(19) United States
(12) Patent Application Publication
(10) Pub. No.: US 2012/0123843 A1
(43) Pub. Date: May 17, 2012

(54) Food Product Scale System And Method For Providing In-Store Incentives To Customers

(75) Inventors: Harry W. Collins, Troy, OH (US); Nigel Mills, Kettering, OH (US); Robert J. Schuller, Troy, OH (US)

(73) Assignee: VALASSIS IN-STORE SOLUTIONS, INC., Livonia, MI (US)

(21) Appl. No.: 13/295,169

(22) Filed: Nov. 14, 2011

Related U.S. Application Data
(63) Continuation of application No. 11/586,816, filed on Oct. 26, 2006, now abandoned.
Application No. 11/586,816 is a continuation-in-part of application No. 10/423,471, filed on Apr. 25, 2003.
(60) Provisional application No. 60/376,184, filed on Apr. 29, 2002.

(51) Int. Cl. G06Q 30/02

(52) U.S. Cl. 705/14.25

(57) ABSTRACT

A food product scale system includes a video commercial advertisement feature that is linked to an incentive item associated with a food product being weighed, where a coupon or other incentive label may also be printed for the incentive item.

### CROSS-REFERENCE TO RELATED APPLICATIONS

This application is a continuation of application Ser. No. 11/586,816, filed Oct. 26, 2006, which is a continuation-in-part of application Ser. No. 10/423,471, filed Apr. 25, 2003, which application in turn claims the benefit of U.S. Provisional Application No. 60/376,184, filed Apr. 29, 2002.

### TECHNICAL FIELD

The present invention relates generally to in-store scales utilized for weighing food products and printing labels applied to weighed products, and more particularly, to a method and system for enhancing the effectiveness of promotions/incentives via an in-store scale.

### BACKGROUND

The perishable foods sections of most supermarkets and grocery stores such as the meat department, bakery, deli and produce department, typically include one or more in-store scales having printers for printing labels with item name, weight or count, and price information. The labels are then applied to the packaged items. Many such printers are provided as part of in-store scales or systems including scales.

Increasingly, in-store equipment such as scales/scale systems may include a communications link for receiving information from sites external to the store. As used herein the term scale system refers to any scale device or any larger device that includes a scale, such as a weigh/wrap machine. For example, prior art scale systems exist in which pricing information in the goods database is updated remotely from a central location so that all related stores in a chain use the same pricing scheme. Chain personnel can also use communications links with in-store scale systems to monitor scale status/function. Still further, prior art in-store scale systems exist that are capable of printing two labels, one which includes the product and price information for a given product and another that prints a marketing message for that same product or prints a generic marketing message. An example of such a prior art system is illustrated in FIG. 16 where a store 300 is shown and external site 302 is shown. A scale system 304 including a controller 306 and associated printer 308 is located in the store 302, along with a second printer 310 that is connected to controller 306 for control thereby. The controller 306 is also connected via communications link 312 to a computer 314 at external site 302. In the illustrated system, computer 314 has been used to control pricing information used by scale 304 for printing on a first label by printer 308, and to also control merchandising messages printed on a second, separate label by printer 310, where the pricing information printed by printer 308 and the merchandising information printed by printer 310 related to the same product. Examples of merchandising messages printed on the second label by printer 310 include “Great For The Grill” or “100% Pure Ground Beef” or “50 Cents Off”. Such prior art systems have also been used to print similar merchandising messages, regarding the product to which a pricing label is applied, on the pricing label itself. This system did not provide for any cross-marketing type incentives.

It is known to provide coupon dispensing printers at the point of sale in supermarkets and groceries. Typically such coupon dispensers print coupon or other incentive information on paper stock based upon purchases made or not made by the consumer. For example, the items scanned at the point of sale are tracked and a database of incentives to be provided based upon the purchase of a certain product, combination of products, or an amount of a certain product or combination of products may be used to generate incentives for printing at the point of sale. Likewise, the database may generate incentives based upon the failure of the consumer to purchase a certain product or combination of products, or an incentive may be generated based upon identifying the customer and referring to a prior shopping history. While such systems have proven somewhat effective, they still suffer the drawback of not placing the incentive into the possession of a consumer until the consumer is on the way out the door.

Product manufacturers, distributors, advertisers and store operators are continually looking for new and improved ways to market and advertise products within the store. Accordingly, given the number of labels printed on a daily basis by such scales, and the fact that the packages containing such labels are typically placed directly in front of consumers or into the consumer's hands, it would be desirable to utilize such scales to deliver marketing and promotional messages for numerous products in a controlled manner.

Moreover, in connection with in-store scale systems that print coupons, or other types of promotions, as part of, or separate from, product pricing labels in order to cross-market another store item based upon a specific food item being weighed at the scale, it would be desirable to enhance the effectiveness of such a coupon distribution system to improve coupon or promotion redemption

### SUMMARY

In a first aspect, a method is provided for delivering a coupon promotion to a consumer in a store utilizing a scale system located in a perishables department of a store, the scale system including a weighing station, a label printing mechanism and at least one consumer display. The method includes the steps of: identifying a product being weighed; based upon identity of the weighed product, (a) obtaining pricing data for the weighed product, (b) obtaining incentive label data for an incentive product associated with the weighed product, (c) obtaining video commercial advertisement data for the incentive product, (d) during the weighing process, (1) displaying for consumer viewing calculated price information for the weighed food product, and (2) outputting the video commercial advertisement for the incentive product; printing on a label both (i) product price information for the weighed food product and (ii) coupon information for the incentive product; applying the label to a package containing the weighed food product; and providing the package to the consumer.

In another aspect, a method is provided for delivering a promotional message to a consumer in a store utilizing a scale system located in a perishables department of a store, the scale system including a weighing station, a label printing mechanism and at least one consumer display. The method includes the steps of: identifying a product being weighed; based upon identity of the weighed product, (a) obtaining pricing data for the weighed product, (b) obtaining video commercial advertisement data for a promoted product associated with the weighed product, (c) during the weighing process, (1) displaying for consumer viewing calculated price information for the weighed food product, and (2) outputting the video commercial advertisement for the promoted product.

In another aspect, a scale for weighing products includes a weighing device for producing weight indicative signals, a controller for receiving weight indicative signals from the weighing device, at least one label printing mechanism connected to receive print control signals from the controller, and an input device, with the controller connected to receive signals from the input device. The controller has at least one operating mode during which the controller will operate to: based in part upon a first item identifier for a first item and a received weight indicative signal for the first item, calculate a price for the first item and effect printing of a product label, including printing on the product label the price of the item and a scannable bar code; access an incentive database based upon the first item identifier to determine if an incentive link exists for the first item; if an incentive link exists for the first item, effect printing of an incentive label containing an incentive for a second item that is different than the first item, where the incentive label is separate from the product label.

In another aspect, a scale for weighing products includes a weighing device for producing weight indicative signals, a controller connected for receiving weight indicative signals from the weighing device, at least one label printing mechanism connected to print labels under control of the controller, an input device, with the controller connected to receive signals from the input device, and a display screen connected to display information under control of the controller. The controller has at least one operating mode during which the controller will operate to: based in part upon a first item identifier for a first item and a received weight indicative signal for the first item, calculate a price for the first item; access an incentive database based upon the first item identifier to determine if multiple incentives are associated with the first item and, if so, effect display of multiple incentive indications on the display screen, the multiple incentives relating to one or more items that are different than the first item; and responsive to input of a selected incentive from among those displayed, effect printing of the selected incentive on a label.

In a further aspect, a scale for weighing products includes a weighing device for producing weight indicative signals, a controller connected for receiving weight indicative signals from the weighing device, at least one label printing mechanism connected to print labels under control of the controller, an input device, with the controller connected to receive signals from the input device, and a display screen connected to display information under control of the controller. The controller has at least one operating mode during which the controller will operate to: based in part upon a first item identifier for a first item and a received weight indicative signal for the first item, calculate a price for the first item; determine if a second item progressive incentive is associated with the first item and, if so, effect display of progressive incentive information for the second item on the display screen for inviting a customer to purchase more of the first item in order to obtain a more economically advantageous incentive for the second item.

In yet another aspect, a scale for weighing products includes a weighing device for producing weight indicative signals, a controller connected for receiving weight indicative signals from the weighing device, at least one label printing mechanism connected to print labels under control of the controller, an input device for inputting item identifiers, with the controller connected to receive signals from the input device, and a display screen connected to display information under control of the controller. The controller has at least one operating mode during which the controller will operate to: based in part upon an input first item identifier for a first item and a received weight indicative signal for the first item, calculate a price for the first item; determine if multiple incentives are associated with the first item and, if so, effect printing of a first incentive for a second item on one label and printing of a second incentive for a third item on another label to facilitate providing two incentive labels to a customer based upon the customer's interest in the first item.

In still a further aspect, a method of modifying an existing scale to facilitate production of incentive labels is provided, where the scale located in a perishable food department of a store for printing product labels based upon weighing of items. The method involves the steps of: loading a program segment or segments into memory of the scale, where the loaded segment or segments will effect the following steps when an item identifier is provided to the scale for a first item, the first item is the weighed by the scale and a product label is produced for the first item: accessing an incentive database based upon the item identifier to determine if an incentive link exists for the first item; and if an incentive link exists for the first item, printing an incentive label containing an incentive for a second item that is different than the first item.

In another aspect, in a store including a plurality of point of sale terminals and one or more perishable food departments, at least one perishable food department having a scale installed therein for weighing items and printing product labels for the items, a method of providing an incentive label to a customer involves the steps of: providing to the scale an identifier of a first item; weighing the first item; based upon a weight of the first item, the scale calculating a price for the first item and printing a product label including the price of the item and a scannable bar code; determining if an incentive link exists for the scale; if an incentive link exists, printing an incentive label containing an incentive for a second item that is different than the first item; and wherein a product display unit is positioned proximate to the scale and holds and displays the second item.

In a further aspect, in a store including a plurality of point of sale terminals and one or more perishable food departments, at least one perishable food department having a label printer installed therein for printing product labels based for items, a method of providing an incentive label to a customer involves the steps of: providing to the label printer an identifier of a first item; based upon at least the identifier for the first item, establishing a price for the first item; accessing an incentive database based upon the first item identifier to determine if an incentive link exists for the first item; if an incentive link exists for the first item, the label printer printing an incentive label containing an incentive for a second item that is different than the first item; wherein the incentive label includes at one fold line therein to divide the label into at least first and second parts, in the printing step a coupon bar code is printed on a label print side of the first part and incentive identification indicia is printed on a label print side of the second part, the coupon is folded along the fold line such that the first part is located beneath the second part and is adhesively held thereto.

In yet another aspect, a labeled package assembly includes a package containing a first product and a label attached to the package. The label includes a separation line dividing the label into first and second parts, the second part including a fold line dividing the second part into first and second sub-parts. The first and second sub-parts are substantially the same size and the first sub-part is folded under the second-subpart and adhesively attached thereto. The first sub-part includes a scannable coupon bar code thereon that relates to a second product that is different than the first product, the scannable coupon bar code facing inwardly toward the package. The second sub-part is adjacent the separation line and includes indicia specifying incentive information for the second product. The first part is adhesively attaches the label to the package such that the first part is fixed to the package while enabling the second part to be removed from the package by tearing along the separation line.

### BRIEF DESCRIPTION OF THE DRAWINGS

FIG. 1 is a schematic diagram of a system including an exemplary scale in accordance with one or more embodiments of the present application;

FIG. 2 is a schematic diagram of a store incorporating the system in accordance with one or more embodiments of the present application;

FIG. 3 is a schematic diagram of an alternative scale in accordance with one or more embodiments of the present application;

FIG. 4 is an exemplary label construction in accordance with one or more embodiments of the present application;

FIG. 5 is an alternate view of the label construction depicted in FIG. 4;

FIG. 6 is another exemplary label construction in accordance with one or more embodiments of the present application;

FIG. 7 is an alternate view of the label construction depicted in FIG. 6;

FIG. 8 is a scale system in accordance with one or more embodiments of the present application;

FIG. 9 is an exemplary environmental diagram in accordance with one or more embodiments of the present application;

FIGS. 10A-C are exemplary displays for a scale in accordance with one or more embodiments of the present application;

FIG. 11 is another exemplary label in accordance with one or more embodiments of the present application;

FIGS. 12A-B are additional exemplary labels in accordance with one or more embodiments of the present application;

FIG. 13 is a package having an exemplary label applied thereto in accordance with one or more embodiments of the present application;

FIG. 14 is schematic diagram of a system in accordance with one or more embodiments of the present application;

FIG. 15 is a schematic representation of a scale in accordance with one or more embodiments of the present application;

FIG. 16 illustrates a prior art system;

FIG. 17 is an exemplary flow diagram in accordance with one or more embodiments of the present application;

FIG. 18 is an front view of a scale in accordance with one or more embodiments of the present application;

FIG. 19 is a side view of a scale in accordance with one or more embodiments of the present application; and

FIG. 20 is a perspective view of a scale in accordance with one or more embodiments of the present application.

### DETAILED DESCRIPTION

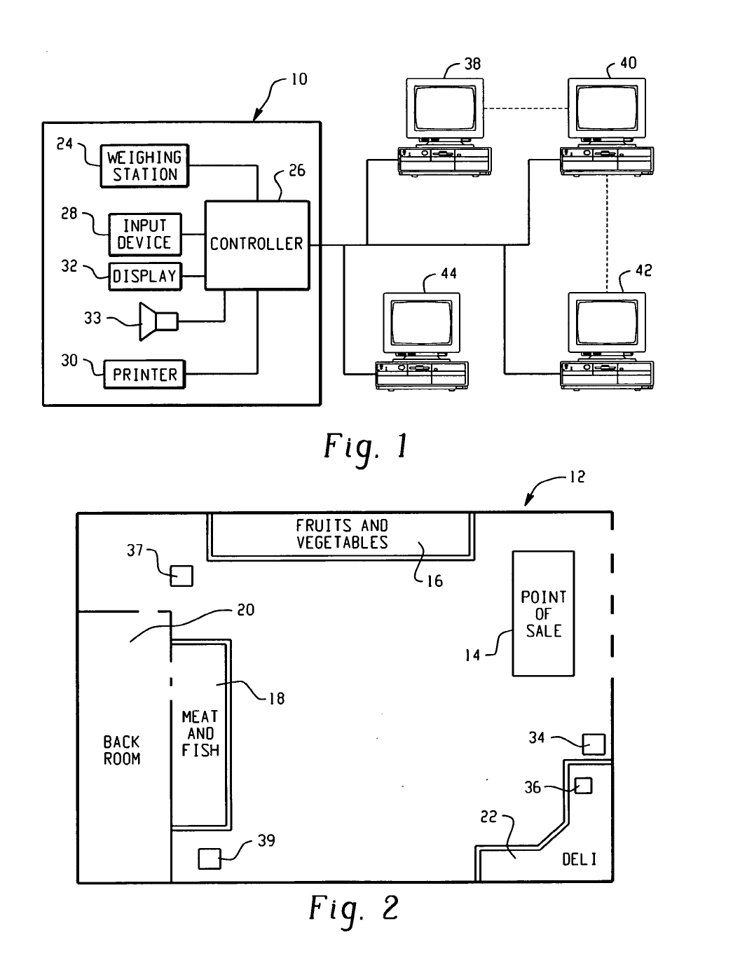

In one embodiment, a food product scale 10 (FIG. 1) is used to provide incentives at desired locations within the store 12 (FIG. 2). The store 12 may typically include a point of sale 14 with associated check out scanning terminals. The scale 10 is preferably located at another location, such as a perishables department as represented by the fruit and vegetable department 16, the meat and fish department 18 or associated back room 20, or the deli department 22 or the bakery department (not shown) so that incentives can be provided to customers prior to the actual purchase of any products and prior to the customer being on the way out of the store.

Referring again to FIG. 1, the scale 10 includes an associated weighing station 24 having a load cell or other known weighing mechanism or device to produce weight indicative signals that are passed to a processor-based controller 26. A user input device 28 (such as a keypad, a touch sensitive display, a scanner, etc) is also connected to the controller 26. The user input device 28 may be utilized by store personnel (or in the case of a self service situation the customer) to identify the product being weighed, usually by a PLU (price look-up) number. Item identifiers for products being weighed may take other forms as well. For example, the input device could comprise a large number of keys, one for each product that might be weighed. The controller 26 refers to a price database (stored in suitable memory of the controller or accessible via a link to another computer system such as a P.O.S. system or a regional or national computer system of a store chain) to identify the price per unit weight linked to the entered PLU or other product identifier, and calculates a total price for the product based upon the weight as indicated by the weight indicative signals received from the weighing station 24. The controller 26 then establishes product print data (such as total price, price per unit weight, product bar code, logos or other image data, label set-up and format) to be delivered to a printing mechanism 30. The printing mechanism 30 includes a print head and associated supply of adhesive labels to be applied to products once the product print data is printed on a label (“product label”) and the product label is output. The print head may be a thermal print head, with the labels including a thermally activated layer. However, it is recognized that other print head types and corresponding label types could be used. The adhesive side of the labels may be entirely or partially coated with adhesive. The labels may be formed of any suitable material. The various components of the scale 10 could be integrated into a single housing or unit. Alternatively, the scale 10 may be formed of components formed as separate units and connected together for communication with each other, in which case the controller may be a distributed controller, with various control functions distributed among the components. As used herein the terminology “controller” is intended to encompass the distributed controller configuration. Further, the term “controller” is intended to broadly encompass the collection of circuits, processors and other components that carry out the various operating and processing functions of the scale and its component parts.

To provide marketing incentives from the scale 10, the controller 26 also accesses an incentive database or database(s) (stored in suitable memory of the controller or accessible via a link to another computer system such as a P.O.S. system 38 or other in-store system 44 or a regional 40 or national 42 computer system of a store chain) that identifies incentives linked to specific products based upon the PLU number or other product identifier. The incentive database(s) could be incorporated into the price database or could be a separate database. The incentive database identifies whether there is an incentive linked to the product that is weighed and for which a product label having price information is printed. If there is an incentive linked to the product, the incentive database also identifies the details of the incentive. By way of example, the incentive link could be the incentive (graphic and or data) itself, could be a number or numbers representing an incentive data memory location, could be a simple state bit used as a flag, or could simply be the inclusion of the specific product (i.e., the product being weighed) in the incentive database. Importantly, the incentive that is linked to any specific product will typically be for a different product. Usually the different product will be a product that is complementary to the weighed product as opposed to a product that is competitive with the weighed product. For example, for a given brand of deli ham that is weighed an incentive might be provided for a product such as a particular brand of mayonnaise, mustard or potato chips. As another example, when celery or carrots are weighed an incentive might be provided for a particular brand of vegetable dip, or when salad is weighed an incentive might be provided for a particular brand of salad dressing.

As used herein the term “weighed product” will be used to refer to the product that is weighed by the scale and that may have an incentive linked therewith and the term “incentive product” will be used to refer to a product to which an incentive relates. If an incentive is linked to a weighed product, the controller establishes incentive print data (such as incentive product name, nature of incentive, expiration date, scannable coupon bar code, logo and/or other graphics data and label set-up and format) to be delivered to the printing mechanism 30 to print an “incentive label” that contains the incentive. The incentive label may be part of the product pricing label, with provision made for separation of the incentive label from the rest of the product pricing label. However, the incentive label might also be a label that is output separate from the product pricing label.

The incentive provided to the consumer will typically be in the form of a coupon. As used herein the term coupon is broadly used to encompass both cents off and percent off type offers, as well as 2 for the price of 1 type offers. The incentive label will typically be printed with the incentive visually stated thereon and with a coupon bar code that can be scanned at the point of sale to effect application of the incentive for a customer purchasing the incentive product, where the point of sale computer terminals access a coupon database and the coupon database links the details of any given incentive with the coupon bar code provided on the incentive label.

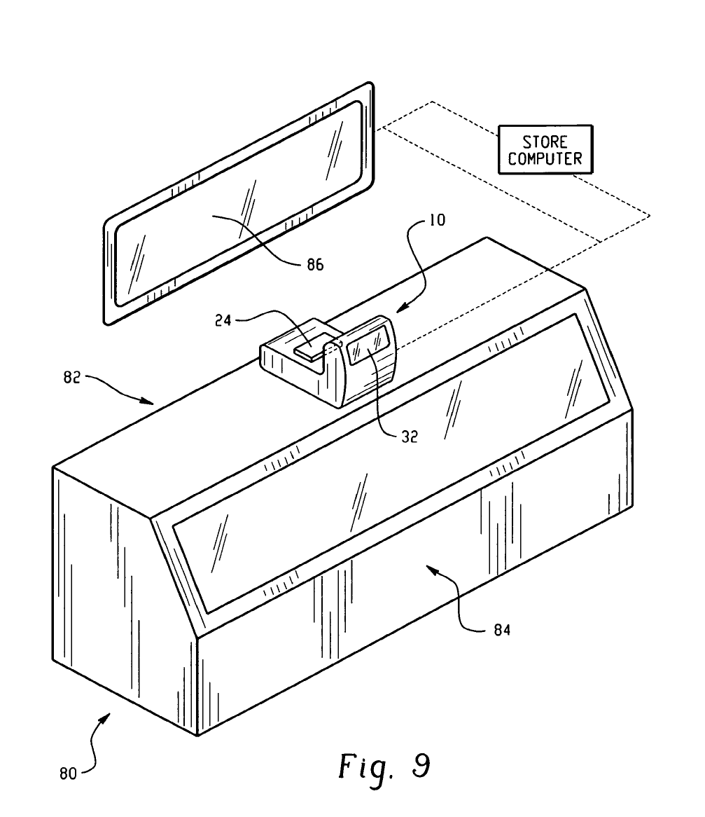

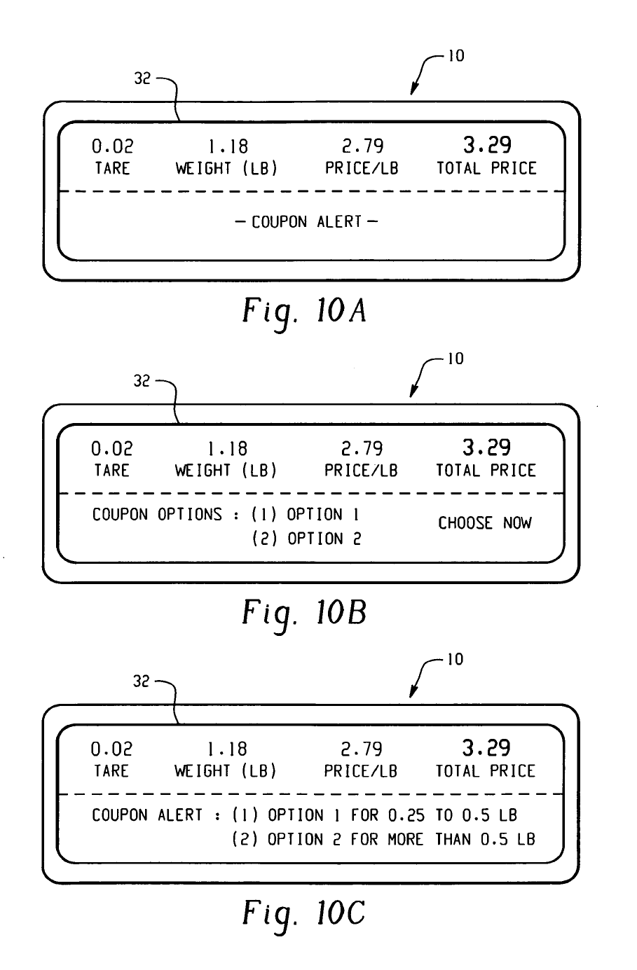

Another possible feature of incentive production by a scale 10 may include the controller 26 notifying the store personnel or customer that an incentive label will be printed by causing a display 32 to display a message advising of the same. Multiple displays 32 may be provided, including a primary operator display, a primary customer display and an auxiliary customer display per the embodiments illustrated in FIGS. 9-10. In FIG. 9, a scale 10 is positioned atop a typical deli display counter 80 with a display 32 facing the customer side 84 of the counter 80. The scale 10 would typically also include an operator display (not shown) facing the store personnel side of the counter 80. The display 32 can be used to display messages to the customer regarding coupon activity. Referring to FIG. 10A, a generic “Coupon Alert” is displayed to advise the customer that a coupon is being issued, enabling the customer to ask for the coupon if the store personnel for some reason fail to provide the coupon to the customer. FIG. 10B illustrates an example where multiple possible coupons or other incentives are linked to the product being weighed. The display 32 displays the incentive options so that one can be selected by the customer. In one embodiment, the customer could advise the store personnel as to the coupon desired, and the store personnel could utilize the input device of the scale to select the desired incentive for printing. In another embodiment, the customer could select the incentive directly using an input device. For example, the display screen 32 could be a touch screen display or the scale could include some other separate customer input device such as a keypad facing the customer. FIG. 10C illustrates an example where the incentive linked with the weighed product is a progressive incentive having discount levels that increase as a function of either the weight or value of the weighed product purchased. In particular, the Option 1 incentive, which applies when the weighed product is between 0.25 and 0.5 pounds, could be a 50 cent coupon while the Option 2 incentive, which applies when the weighed product is more than 0.5 pounds, could be a 75 cent coupon. This type of use of the display 32 in connection with the progressive incentive is designed to impact the customer in a manner causing the customer to purchase more of the weighed food product, with the scale printing the incentive label according to the weight of the weighed product.

It is recognized that other display devices could also be used to display the incentive information to customers. For example, the display 32 could be a primary customer display and an auxiliary, marquee type display could also be attached to the scale 10. Referring again to FIG. 9, another alternative provides a large display 86 that may be mounted on a wall behind the counter 80. The scale 10 could be connected to control the display 86 either directly or indirectly, such as through a store computer system. The large display 86 could also be used to regularly display all incentive options available that day, meaning that each product having a linked incentive would be identified and the corresponding incentive product or products as well as the incentive level or levels could be displayed, so as to influence a customer's shopping decision based upon the incentive that might be obtained.

A scale 10 could also include an audio capability, as provided by a small speaker or other sound emitting device (not shown), in which case a verbal message could be initiated advising the customer of the incentive.

Another possible feature of incentive production by a scale 10 may include printing on the incentive label the location within the store where the incentive product is located, enabling the customer to easily find the product if desired. See for example the label shown in FIG. 11.

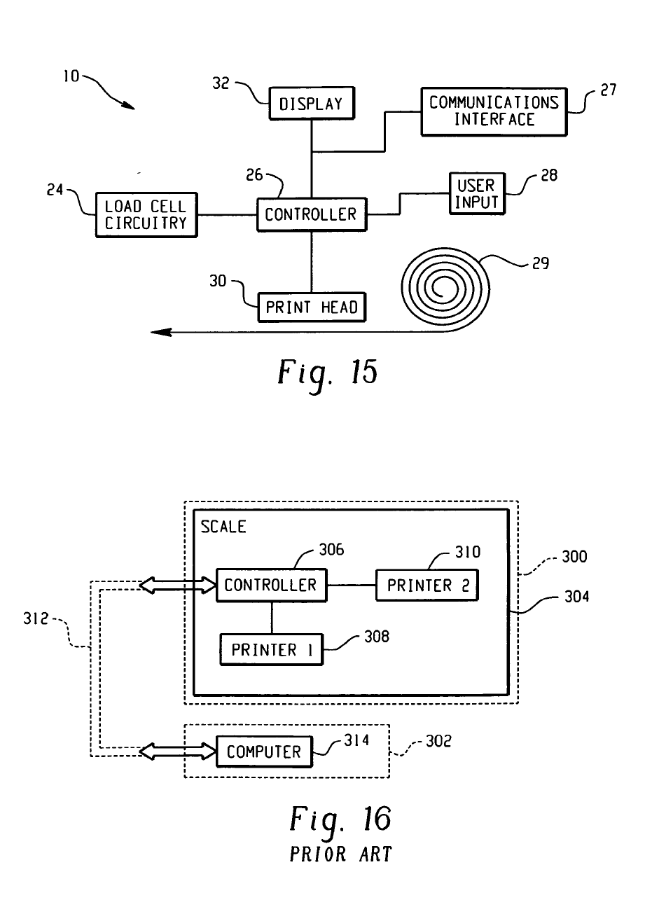

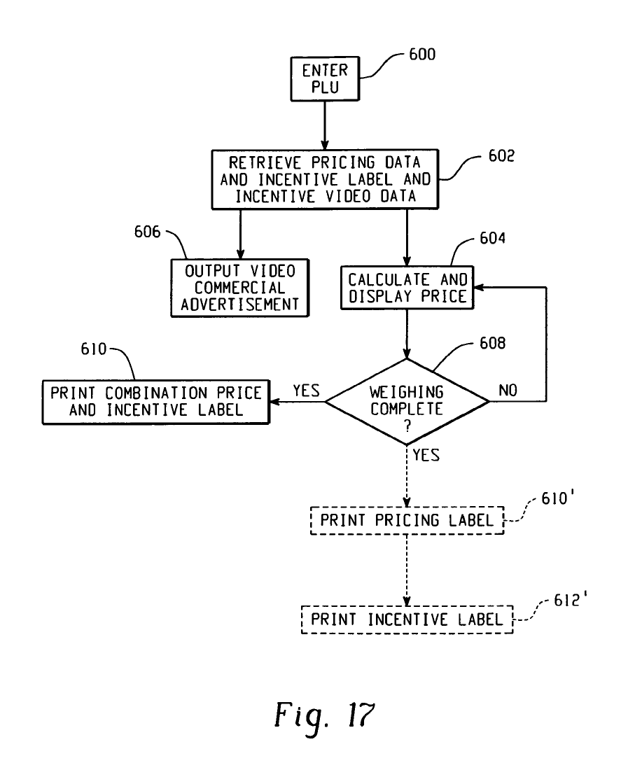

Still a further possible feature of incentive production by a scale 10 may include providing a product support and display unit proximate to the location where the scale is located so that after the incentive label is placed in the hand of a customer, one of the first things the customer sees when moving on is the exact product to which the incentive applies. For example, referring again to FIG. 2, assuming the scale 10 is located in the deli department 22, an end-cap type display unit 34 at the end of the deli-counter and/or an on-counter display unit 36 may hold one or more incentive products.

Where the incentive database is stored in memory of the controller 26 of the scale 10, it is contemplated that the database could be altered by receipt by appropriate downloads, or other type of interfacing, from other in-store computer systems 38, a chain's regional computer system 40 or a chain's national computer system 42. In this regard, the controller 26 of FIG. 1 could include appropriate communications interface 27 (see FIG. 15) capabilities as needed, such as hardwired interfaces or wireless interfaces. In one embodiment, the scale interface could utilize a web server, but it is recognized that other interface types and protocols could be used. Referring again to FIG. 1, a separate entity's computer system 44 (not the store or store chain) might also control the incentive database.

FIG. 14 illustrates an embodiment in which a scale 10 is located in a store 12 and is connected for communication with a store computer system 38, a point-of-sale computer system 39 and a regional computer system 40 of the store chain. FIG. 15 is a schematic representation of the scale 10 including communications interface 27 of the controller 26, and an associated supply of labels in the form of a label roll 29. In the case of liner-type labels, the roll 29 includes a backing with a release coating and multiple adhesive labels positioned thereon.

The controller 26 of the scale 10 may also include tracking software for maintaining a running count of number of incentives provided for each incentive product to facilitate the task of charges that may apply on a per incentive basis, or for use in identifying the redemption rate of incentives. The tracked incentive data may be accessed remotely (such as by one or more computer systems 38, 40, 42, 44 of FIG. 1) or the controller 26 may be programmed to automatically send this information to an appropriate computer system. Incentive label tracking may be performed on a per incentive product basis, on a per manufacturer basis where the manufacturer has more than one incentive product for which incentive labels are generated, or on any other suitable basis or combinations of the same.

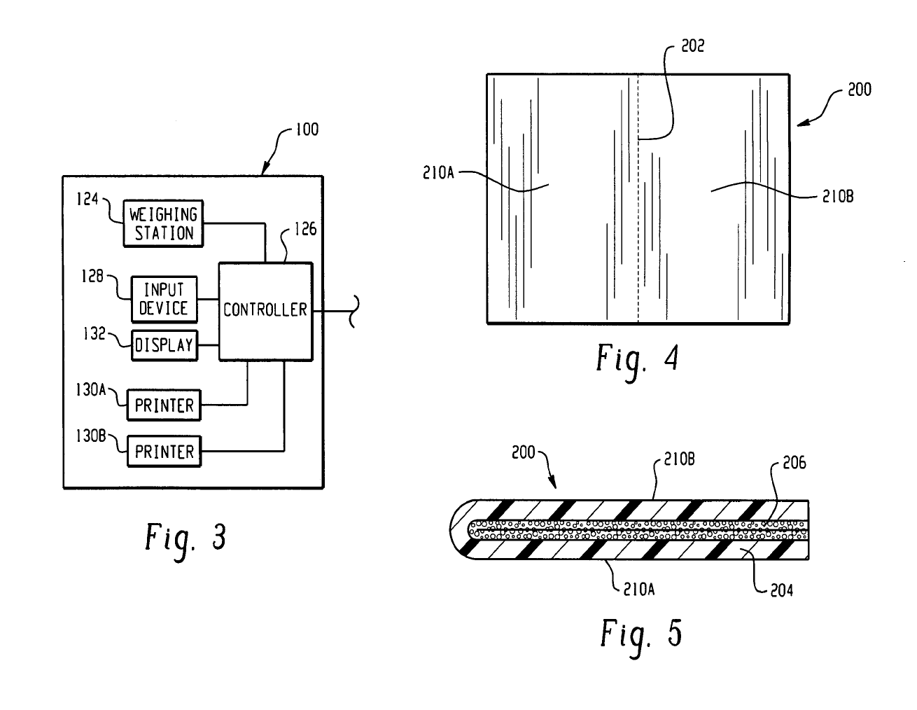

One alternative embodiment of a scale 100 is shown in FIG. 3 where two printer mechanisms 130A and 130B are provided, each having its own supply of labels and its own print head. In this configuration the product label is printed by one printer mechanism 130A and the incentive label is printed by the other printer mechanism 130B. In this technique different label sizes and/or configurations could be used as between the product labels and the incentive labels. Both printer mechanisms 130A and 130B could be integrated within the scale 100 or, alternatively, one or both of the printer mechanisms could be an add on device.

Referring to FIG. 4, an embodiment of an exemplary label construction 200 that can be used in connection with printing incentive labels is shown. The label 200 includes a fold line 202 along its midpoint. The fold line could be a series of perforations or could be a score line in the label. The fold line advantageously enables store personnel (or the customer) to fold the label upon itself as shown in FIG. 5 so that the adhesive side of the label is substantially covered to facilitate manual handling of the incentive label. The folded incentive label 200 includes the non-tacky paper or plastic portion 204 arranged to the outer side and the tacky adhesive layer 206 arranged to the inner side of the resulting label construction. Such a label can be described as having two parts or segments 210A and 210B, and it is contemplated that different incentive information could be printed on the two segments. Alternatively, incentive information could be printed on one segment and other information could be printed on the other segment.

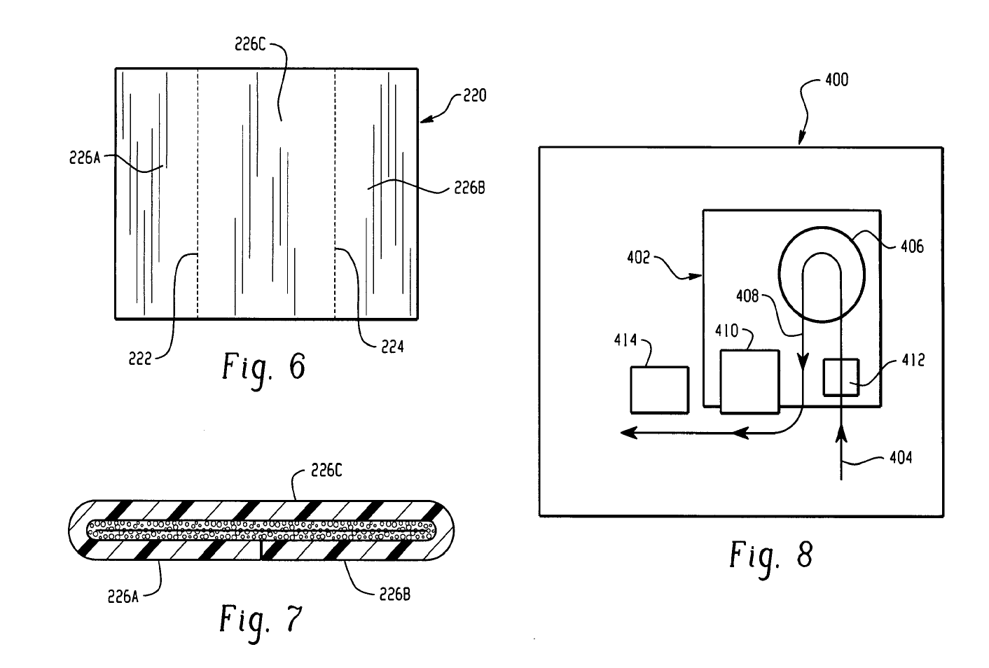

Another possible label construction 220 is shown in FIG. 6 where the label is provided with two fold lines 222 and 224, creating three label parts or segments 226A, 226B and 226C. The two label segments 226A and 226B are folded under as reflected in FIG. 7, again to place the adhesive layer to the inner side of the resulting label construction.

It is also recognized that the incentive label need not be folded upon itself. For example, particularly in the case of embodiments having two printer mechanisms, the supply of incentive labels associated with the incentive printer mechanism could be labels that have only a slight tackiness that is sufficient to allow the incentive labels to be applied to a weighed product while still permitting a customer to easily remove the incentive label from the product. As another alternative, the second printer mechanism that is used to print incentive information could include a supply of non-label media, such as paper or plastic media having no tackiness at all. As used herein the term “incentive ticket” is used to encompass both labels having incentive information printed thereon and non-label media having incentive information printed thereon. Incentive information could be provided to customers in other formats as well.

An embodiment of a back room type scale system 400 is shown in FIG. 8. A weigh/wrap machine 402 includes an infeed 404 for receiving packages. A conveyor transports the package to a wrap station 406 where the package is typically lifted vertically into film for wrapping. The wrapped package is then conveyed to an outfeed location 408 and moved toward a label printer mechanism 410 where a product label is applied. In this regard, a weighing station 412 may be provided at the infeed 404 for weighing each package. The printer mechanism could be used to apply both a product label and an incentive label, with a controller of machine 402 operable to access an incentive database (within memory of the machine 402 or accessed remotely) to determine if the weighed product includes an incentive linked thereto and, if so, to produce the incentive print data for the printer mechanism 410 to print an incentive label that could also be automatically applied to the product. Alternatively, an additional printer mechanism 414 may be positioned alongside the weigh/wrap machine, and connected for communication therewith, for printing and applying incentive labels to the wrapped package when incentive links exist in the incentive database. In this regard, the controller of machine 402 could access an incentive database or a controller of printer mechanism 414 could access an incentive database. The multiple printer mechanism arrangement could allow for the second printer mechanism 414 to include a supply of labels with a relatively low adhesion so that a customer could remove the incentive label from a package and hand the incentive label to the check out personnel as a coupon.

In another embodiment a scale having a single printing mechanism could include a supply of labels with alternating label types, one for use in printing product labels and the other for use in printing incentive labels. Such a label supply might most often be used for back room systems of the type described above where the same product is often wrapped and labeled in large quantities. For example, referring to FIG. 8 the printing mechanism 410 could include a supply of two different types of labels that alternate between two types, where the two types have different configurations and/or different adhesive properties.

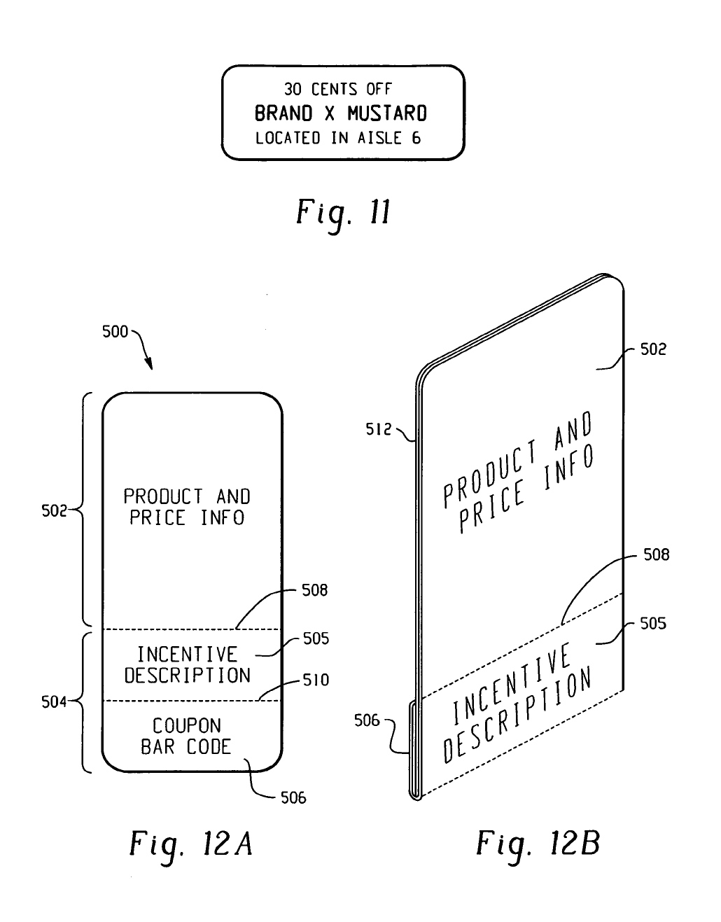

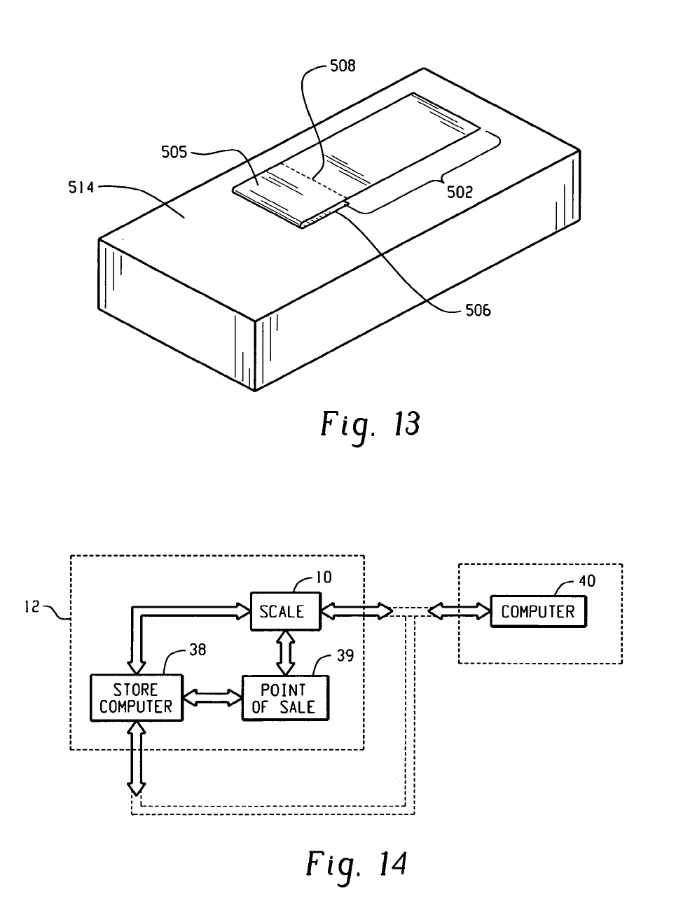

Another embodiment of a label and resulting package assembly useful in connection with the incentive features described herein is shown in FIGS. 12 and 13. FIG. 12A shows an upper, printing surface of a label 500 having parts or regions 502 and 504. A separation line 508, which by way of example may be a series of perforations or a score line in the label, divides part 502 from part 504. A fold line 510 divides part 504 into sub-parts 505 and 506. It is contemplated that an entirety of the rear surface of the label would include an adhesive layer, although less than the entirety of the surface could be adhesive. The label 500 can be used in connection with scale label incentives as follows. When a product is weighed and the price of the product calculated, the printing mechanism prints price and product information, which may include a pricing bar code, on part 502. If the weighed product includes an incentive link, the printing mechanism prints incentive information on one or both of sub-parts 505 and 506. In one example, indicia identifying the nature of the incentive to the customer is printed on sub-part 505, and a coupon bar code is printed on sub-part 506. The label sub-part 506 is then folded under the label sub-part 505 to produce a folded label as shown in the perspective of FIG. 12B where the adhesive layer 512 is illustrated for ease of understanding. The folded label can then be applied to a package 514 per FIG. 13 to produce a labeled package assembly. In the illustrated embodiment label sub-parts 505 and 506 are of similar size. When sub-part 506 is folded under and against sub-part 505 it becomes adhesively attached thereto with the coupon bar code facing the opposite direction of the incentive description. When the folded label is applied to package 514, only label part 502 is adhesively held to the package because the adhesive on sub-parts 505 and/or 506 is no longer exposed. This construction enables the incentive portion of the label 500, comprised of sub-parts 505 and 506, to be removed from the package for use by a customer by separation along line 508. Alternatively, if the customer chooses not to use the incentive, the coupon bar code is left adjacent to and facing the package so that it will not interfere with any scanning operation at the checkout location of the store.

While much of the foregoing description contemplates the printing of an incentive label that is separate from the product label, it is apparent from the example provided in FIGS. 12 and 13 that certain features described here could be used in conjunction with an incentive label that is integrated with the product label. Unless otherwise specifically stated in any claim of this application, language describing the printing of an incentive label and the printing of a product label should be interpreted to cover both printing of separate labels and printing of an integrated label.

While the foregoing description has focused primarily upon the use of an incentive database with links between products to print incentive labels, it is recognized that other types of incentive links could be used. For example, an incentive database could include a location link to produce incentive labels. In particular, referring to FIG. 2, the fish and vegetable department 16 of a store may include an associated product display unit 37 in proximity thereto and holding and displaying a first incentive product, the meat and fish department 18 may include an associated product display unit 39 holding and displaying a second incentive product and the deli department 22 may include product display unit 34 and/or 36 holding and displaying a third incentive product. The incentive database, which could be the same for scales located in each of departments 16, 18 and 22 could include incentive links based upon the location of the scale (for example, by department) and would incorporate incentive links for products based upon the known incentive product being displayed in proximity to the department in which the scale is located. Each scale could be programmed with an identifying number or a location specific number that is used to access the incentive database. In this way, scales in the fruit and vegetable department 16 could produce incentive labels for products displayed at unit 37 with or without regard to the product being weighed, scales in the meat and fish department 18 could produce incentive labels for products displayed at unit 39 with or without regard to the product being weighed and scales in the deli department 22 could produce incentives for products displayed at units 34 and/or 36 with or without regard to the product being weighed. In the case where the incentive labels are produced without regard to the product weighed, the incentive link could be referred to as a location specific incentive link as opposed to a product specific incentive link.

If the incentive label is part of the product pricing label, it will typically be applied by store personnel to a package containing the weighed product. If the incentive label is separate from the product pricing label it may be handed directly to the customer. In either case, the customer receives the incentive prior to completion of the shopping experience and therefore is more likely to actually utilize the incentive (e.g., purchase the incentive product and redeem the coupon for the incentive product). Nonetheless, the value of such an incentive distribution system can be enhanced if redemption can be increased.

Accordingly, incentive production by a scale 10 may include corresponding generation of a video commercial advertisement for the incentive product via a customer display 32. As used herein the term “video commercial advertisement” means a non-static visual display of content relating to a specific product, with or without accompanying audio content. The term non-static refers to the inclusion of some visually perceivable movement or change in the visual display during its duration. In one implementation such a video commercial advertisement will have a duration of 1 to 15 seconds. In another implementation such a video commercial advertisement will have a duration of 5 to 10 seconds. However, the exact duration can vary.

Where the weighed product and incentive product have a relationship that may be useful in marketing to consumers, both the weighed product and the incentive product may be shown in the video commercial advertisement (e.g., when ham is weighed a video commercial advertisement depicting a ham sandwich with Dijon mustard being applied may be displayed, where the mustard is the incentive product). Other techniques may be used in the video commercial advertisement to communicate the relationship between the weighed product and the incentive product.

Multiple customer displays 32 may be provided. By way of example, multiple customer displays may be provided per the examples illustrated in FIGS. 3 and 4 of U.S. Patent Publication No. 2003/0037965 A1 or FIG. 9 herein. During a food product weighing operation many consumers tend to be observant of the weighing operation by looking at the scale and its display to assure that a requested amount of food product is provided. Accordingly, in order to best take advantage of the marketing opportunity provided by a consumer's attention to a weighing operation, it is preferred that the subject video commercial advertisement be displayed on a display that is part of or at least in close proximity to the scale being used to weigh the food product. The video commercial advertisement and pricing information may be displayed on a common consumer display (separated by position and/or time) or on two different consumer displays.

In order to implement the video commercial advertisement feature, the incentive database may include an associated video file (e.g., a digital video file or an analogue video file). By way of example, any suitable digital video file format could be used, such as Advanced Streaming Format (ASF), Audio Video Interleave (AVI), MPEG-1, MPEG-2, QuickTime (QT), QuickTime Pro, RealMedia (RM), Windows Media Video (WMV), DivX or MJPEG. It is recognized that a separate database (stored in suitable memory of the controller or accessible via a link to another computer system such as a P.O.S. system or other in-store system or a regional or national computer system of a store chain) could be provided for the video file associated with incentives. The scale 10 may also include one or more audio output devices (e.g., speakers) 33 (shown in FIG. 1) to generate the audio portion of any video commercial advertisement including such an audio portion. However, it is recognized that is may be desirable to permit scale operators to disable the audio portion of video commercial advertisements.

Operationally, the scale may be configured such that when an item identifier is input to the scale, the controller refers to appropriate databases to identify whether an incentive exists and, if so, utilizes stored incentive information to generate (i) only an incentive label for an incentive product, (ii) both an incentive label and a video commercial advertisement for the same incentive product or (iii) only a video commercial advertisement for an incentive product. The preferred technique is to generate both the incentive label and the video commercial advertisement so as to increase the likelihood that the consumer will purchase the incentive product during the current visit to the store.

The timing of generation of the commercial video advertisement is considered important to enhancing the effectiveness of the promotion. Accordingly, referring now to FIG. 17, during a weighing transaction the scale operator inputs a PLU number for the item being weighed at step 600 (or some other technique to identify the product to the scale is used). Based upon the product identification, pricing data, incentive label data and incentive video data are retrieved at step 602. The price for the item being weighed is calculated and displayed at step 604. At the same time, the video commercial advertisement is output via a consumer display and audio output device at step 606. When the weighing operation is complete at step 608 (typically indicated by a scale operator hitting a label print key) a label is printed at step 610 including the product pricing information and the incentive information (e.g., a coupon part). Alternatively, as indicated by steps 610′ and 612′, a separate product pricing label and incentive label may be printed. Depending upon the length of time taken by an operator to complete a weighing operation, as well as the duration of the video commercial advertisement, the video commercial advertisement may complete prior to the time of label printing or may continue during the label printing. The scale could also be configured such that entry of a new PLU during output of a given video commercial advertisement (corresponding to a previously input PLU) interrupts such output, enabling a video commercial advertisement for the new PLU to be selected and output.

While initiation of output of the video commercial advertisement is triggered above based upon entry of the product identifier and subsequent retrieval of incentive video data, it is possible that further criteria could be set up as prerequisites to initiating output of the video commercial advertisement. For example, a requirement that food product be placed on the weighing station (e.g., as determined by weight signal output) could be utilized.

By displaying a video advertisement for the incentive product during the weighing operation, an attentive consumer observing the weighing operation is given the opportunity to see and hear a message about the incentive product that will make the consumer more likely to utilize the printed coupon for the incentive product.

One alternative embodiment of a scale 100 is shown in FIG. 4 where two printer mechanisms 130A and 130B are provided, each having its own supply of labels and its own print head. In this configuration the product label is printed by one printer mechanism 130A and the incentive label is printed by the other printer mechanism 130B. In this technique different label sizes and/or configurations could be used as between the product labels and the incentive labels. Both printer mechanisms 130A and 130B could be integrated within the scale 100 or, alternatively, one or both of the printer mechanisms could be an add on device.

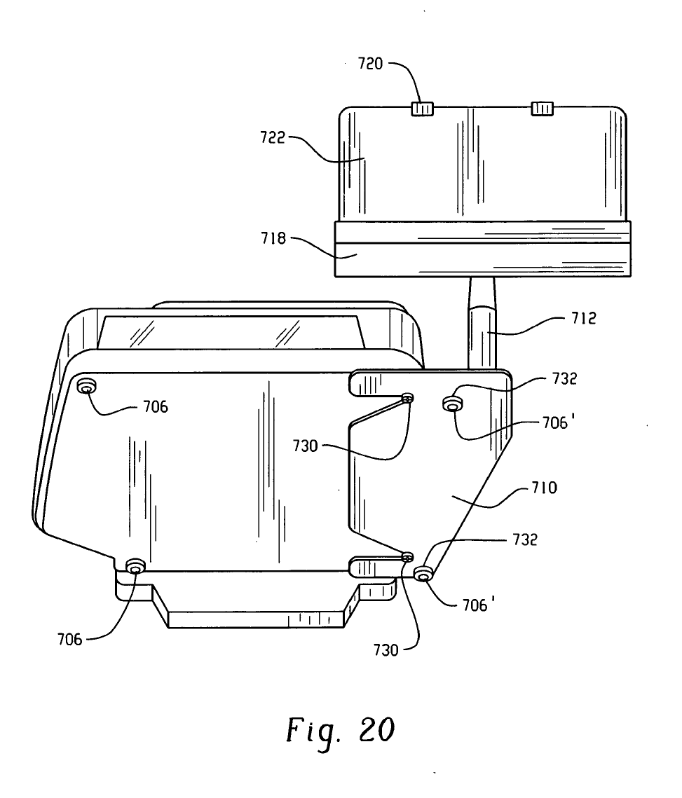

Due to the large number of existing scales already existing within stores, in order to provide the video commercial advertisement feature in connection with such existing scales it may be necessary to provide an “add-on” display unit (with both a display and audio output device). Referring now to FIGS. 18-20, one embodiment of a retrofit arrangement to facilitate such an add-on display unit is provided. Specifically, an existing scale 700 with consumer display 702 and weighing station 704 is shown. The scale includes adjustable support feet 706 for leveling of the scale. The adjustable support feet are threadedly connected into respective openings in the bottom of the scale housing. Operator display 708 is also shown.

The retrofit arrangement includes a support plate 710, post 712 and display holder 714, with exemplary display screen unit (e.g., a flat screen display with integrated speakers) 716. The display holder 714 includes an assembly including lower U-shaped channel or bracket 718 and upper clamp members 720 extending from a back panel 722, all pivotally mounted to the post via pivot assembly 724 having a locking/adjustment arm 726 and pivot axis 728. As best seen in FIG. 7, the support plate is connected to the underside of the scale housing by removing two of the support feet 706′ and using threaded fasteners 730 to connect the plate to the available housing openings. The plate 710 extends outward from the underside of the scale housing and includes threaded openings 732 to enable the support feet 706′ to be repositioned so as to support the support plate 710, as well as the scale housing via the support plate. A rigid connection between the support plate 710 and scale housing enables the support feet 706′ to still serve the function of facilitating scale leveling. The post 712 may be connected to the support plate 710 via a fastener such that, when loosened, the post may be rotated to a desired position enabling directional control of the display screen.

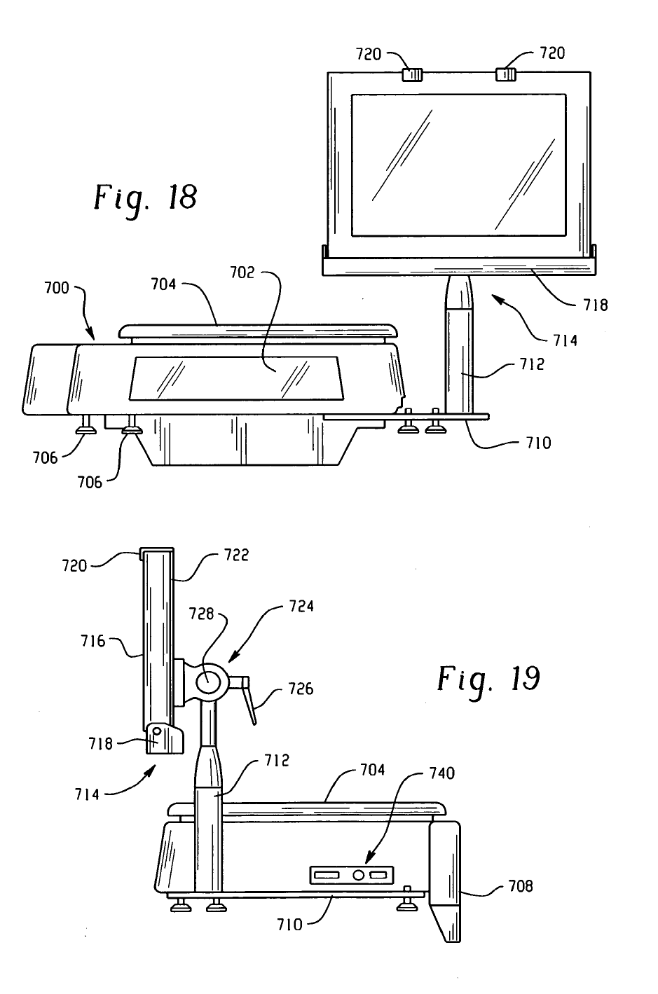

Referring to FIG. 19, communication interface ports 740 of the scale are shown. An appropriate hard-wired connection between the display unit 716 and the scale controller can be achieved using a suitable interface port. Alternatively a wireless connection between the two devices may be used if both devices include wireless capability. In such a retrofit arrangement, the level of communication between the scale and display unit 716 could vary widely. For example, in one arrangement the scale controller may communicate nothing more than a product identifier to a processor of the display unit, with the display unit 716 including one or more integrated databases for referencing incentive label data and incentive video data. In another arrangement, the scale controller may download the entire video file to the display unit 716 each time it is necessary to output a video commercial advertisement.

Although the invention has been described and illustrated in detail it is to be clearly understood that the same is intended by way of illustration and example only and is not intended to be taken by way of limitation. For example, some items include standard weights, such as bakery items in the bakery perishable department, and those items need not be weighed when producing product labels and incentive labels. In such cases the PLU is usually set up to indicate that the item has a standard weight or price and the price for the product label or price is set based upon the standard weight or price. The use of an incentive database in such cases could be the same as any of the foregoing descriptions. Another situation where weighing of an item would not be needed might be in the case of an item that is priced by quantity (number of items) rather than weight (such as apples priced at 3 for $1.00). Because weighing is not a requirement in such instances, the label printer used to print the incentive label need not be associated with a scale.

While certain embodiments have been described above, it is recognized that variations exist, including both narrowing and broadening variations of the appended claims as filed.

What is claimed is:

1. A method of delivering a coupon promotion to a consumer in a store utilizing a scale system located in a perishables department of a store, the scale system including a weighing station, a label printing mechanism, and a display unit having an integrated database and at least one consumer display, the method comprising the steps of:
identifying a product being weighed;
based upon identity of the weighed product,
(a) obtaining pricing data for the weighed product;
(b) prior to purchase of the weighed product, obtaining incentive label data for an incentive product associated with the weighed product;
(c) prior to purchase of the weighed product, obtaining video commercial advertisement data for the incentive product from the integrated database;
(d) during the weighing process of the weighed product,
(1) displaying for consumer viewing calculated price information for the weighed food product, and
(2) displaying a video commercial advertisement for the incentive product based on the video commercial advertisement data for the incentive product;
printing on a label both (i) product price information for the weighed food product and (ii) coupon information for the incentive product;
applying the label to a package containing the weighed food product; and
providing the package to the consumer.

2. The method of claim 1 wherein the scale system includes a first consumer display and a second consumer display, the calculated price information is displayed on the first consumer display, the video commercial advertisement is displayed on the second consumer display.

3. The method of claim 1 wherein the calculated price information and the video commercial advertisement are displayed on a common consumer display.

4. The method of claim 3 wherein the displays of the calculated price information and the video commercial advertisement overlap in time and are separated by position on the common consumer display.

5. The method of claim 3 wherein the display of the video commercial advertisement occurs after the display of the calculated price information.

6. The method of claim 1 wherein both the calculated price information and the video commercial advertisement are displayed on a common consumer display.

7. The method of claim 1 wherein the video commercial advertisement has a duration of 1 to 15 seconds.

8. The method of claim 7 wherein the video commercial advertisement has a duration of 5 to 10 seconds.

9. The method of claim 1 wherein the video commercial advertisement includes an audio portion, the scale system includes an audio output device, and outputting the video commercial advertisement includes generating the audio portion via the audio output device.

10. The method of claim 1 wherein the video commercial advertisement shows both the weighed product and the incentive product.

11. The method of claim 1 wherein the video commercial advertisement communicates a relationship between the weighed product and the incentive product.

12. A scale system for delivering a coupon promotion to a consumer in a store, the system comprising:
a weighing station;
a label printing mechanism;
a display unit having an integrated database and at least one consumer display;
a controller connected to (i) receive weight signals from the weighing station, (ii) control the label printing mechanism and (iii) control the at least one consumer display, the controller operable during a weighing operation to carry out the following steps:
identify a product being weighed;
based upon identity of the weighed product,
(a) obtain pricing data for the weighed product;
(b) prior to purchase of the weighed product, obtain incentive label data for an incentive product associated with the weighed product;
(c) prior to purchase of the weighed product, obtain video commercial advertisement data, including both video data and audio data, for the incentive product from the integrated database;
(d) display for consumer viewing calculated price information for the weighed food product;
(e) display a video commercial advertisement for the incentive product based on the video commercial advertisement data for the incentive product;
print on one or more labels both (i) product price information for the weighed food product and (ii) coupon information for the incentive product.

13. The scale system of claim 12 wherein the scale system includes a first consumer display and a second consumer display, the controller effects display of the calculated price information on the first consumer display, the controller effects display of the video commercial advertisement on the second consumer display.

14. The scale system of claim 13 wherein the first consumer display is integrated with a housing structure of a scale, the second consumer display is attached to the housing structure.

15. The scale system of claim 14 wherein a support plate is connected to an underside of the housing structure, the support plate extends outward from the housing structure, a post extends upward from the support plate, a display holder is connected to the post and the second consumer display is formed by a display unit held by the display holder.

16. The scale system of claim 12, further comprising an audio output device for outputting the audio data as an audio portion of the video commercial advertisement.

17. The method of claim 12 wherein the calculated price information and the video commercial advertisement are displayed on a common consumer display.

18. A method of delivering a promotional message to a consumer in a store utilizing a scale system located in a perishables department of a store, the scale system including a weighing station, a label printing mechanism and at least one consumer display, the method comprising the steps of:
identifying a product being weighed;
based upon identity of the weighed product,
(a) obtaining pricing data for the weighed product;
(b) prior to purchase of the weighed product, downloading, from an external computer system, video commercial advertisement data for a promoted product associated with the weighed product;
(c) during the weighing process of the weighed product,
(1) displaying for consumer viewing calculated price information for the weighed food product, and
(2) displaying a video commercial advertisement for the promoted product based on the video commercial advertisement data for the promoted product.

19. The method of claim 18 wherein the scale system includes a first consumer display and a second consumer display, the calculated price information is displayed on the first consumer display, the video commercial advertisement is displayed on the second consumer display.

20. The method of claim 18 wherein both the calculated price information and the video commercial advertisement are displayed on a common consumer display.

21. The method of claim 18 wherein the video commercial advertisement has a duration of 1 to 15 seconds.

22. The method of claim 21 wherein the video commercial advertisement has a duration of 5 to 10 seconds.

23. The method of claim 18 wherein the video commercial advertisement includes an audio portion, the scale system includes an audio output device, and outputting the video commercial advertisement includes generating the audio portion via the audio output device.

24. The method of claim 18 wherein the video commercial advertisement shows both the weighed product and the promoted product.

25. The method of claim 18 wherein the video commercial advertisement communicates a relationship between the weighed product and the promoted product.
